(19) United States
(12) Patent Application Publication
(10) Pub. No.: US 2018/0118122 A1
(43) Pub. Date: May 3, 2018

(54) SEAT ASSEMBLY WITH INTEGRAL SECURITY PAPERWORK ORGANIZER

(71) Applicant: FORD GLOBAL TECHNOLOGIES, LLC, Dearborn, MI (US)

(72) Inventors: Adrian Rueda Musi, Mexico City (MX); Jordi Vidauri Saiz, Mexico City (MX); Roberto Villegas Muriel, Atizapan de Zaragoza (MX)

(21) Appl. No.: 15/340,361

(22) Filed: Nov. 1, 2016

(51) Int. Cl. B60R 7/04; E05B 49/00; E05B 85/06; E05B 83/28; B60R 11/00; G07C 9/00

(52) U.S. Cl. CPC B60R 7/043; E05B 49/00; E05B 85/06; B60R 2011/0098; B60R 11/00; G07C 9/00571; B60R 2011/0015; E05B 83/28

(57) ABSTRACT

A seat assembly includes a seat, having a seat bottom and seat back, and a security organizer integrated into the seat back. The security organizer includes a hard shell cover, a security lock mechanism that secures the hard shell cover in a closed position and a security compartment fully closed and concealed by the hard shell cover when in the closed position. The security organizer is dedicated to secure paperwork storage within a vehicle.

### TECHNICAL FIELD

This document relates generally to the motor vehicle equipment field and, more particularly, to a seat assembly that includes an integral security organizer for organizing and securing papers, folders, magazines and other documents.

### BACKGROUND

Over the years, motor vehicles have been equipped with a number of storage compartments to conveniently hold and store various items during motor vehicle operation. Such storage compartments include cup holders, glove boxes with secure key lock access, map pockets in a motor vehicle door and accordion bins of flexible, soft fabric material on the rear face of the front seats.

To date, motor vehicles have not been equipped with a lockable and secure storage space dedicated to paperwork storage. This document relates to a seat assembly incorporating a security organizer dedicated to organize and securely hold paperwork at a convenient location within the motor vehicle.

### SUMMARY

In accordance with the purposes and benefits described herein, a seat assembly is provided. That seat assembly comprises a seat including a seat bottom and a seat back and a security organizer integrated into the seat back. The security organizer includes a hard shell cover, a security lock mechanism securing the hard shell cover in a closed position and a security compartment fully closed and concealed by the hard shell cover when in the closed position.

The seat assembly further includes at least one partition in the security compartment. The at least one partition divides the security compartment into multiple sections for organizing paperwork such as folders, files, magazines, notepads and other documents.

The security lock mechanism may include a latch element, a striker and an actuator for releasing the lock mechanism in order to allow displacement of the hard shell cover from the closed position to an opened position allowing access to the paperwork contained within the security compartment. The striker may be carried on the seat back and the latch element and the actuator may be carried on the hard shell cover.

The hard shell cover may be connected to the seat back by means of a hinge. In addition, a first collapsible sidewall may extend between the seat back and a first side margin of the hard shell cover. Further, a second collapsible sidewall may extend between the seat back and second side margin of the hard shell cover.

In some embodiments, the security lock mechanism is electronic. Such a security lock mechanism may include a keypad for entering a code to release the lock mechanism. In some embodiments, the security lock mechanism may include a fingerprint scanner.

In some embodiments, the security lock mechanism includes a key cylinder for receiving a dedicated key to release the security lock mechanism. In other embodiments, the security lock mechanism may comprise a voice actuation circuit to allow one to release the security lock mechanism upon voice command.

In the following description, there are shown and described several preferred embodiments of the seat assembly. As it should be realized, the seat assembly is capable of other, different embodiments and its several details are capable of modification in various, obvious aspects all without departing from the seat assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the seat assembly and together with the description serve to explain certain principles thereof. In the drawing figures:

FIG. 1 is a rear perspective view of a seat assembly which incorporates a security organizer for paperwork.

FIG. 2 is a view similar to FIG. 1 but showing the hard shell cover in the opened position to allow access to the security compartment that is divided into multiple sections by the partitions to allow for the organizing of paperwork.

FIG. 3 is a detailed elevational view of one possible embodiment of the security lock mechanism of the security organizer wherein that security lock mechanism incorporates a key cylinder lock and a push button actuator for opening the hard shell cover of the security organizer.

FIG. 4 is a schematic block diagram of an alternative embodiment of security lock mechanism that is electronic in nature.

Reference will now be made in detail to the present preferred embodiments of the seat assembly, examples of which are illustrated in the accompanying drawing figures.

### DETAILED DESCRIPTION

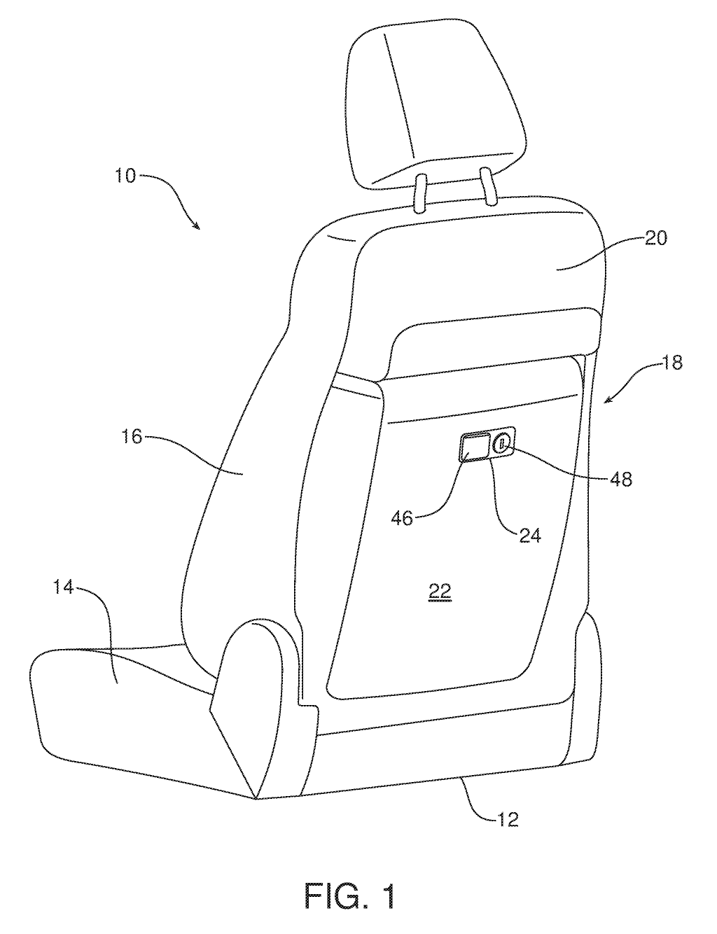

Reference is now made to FIGS. 1-3 illustrating the seat assembly 10. That seat assembly 10 includes a seat 12 including a seat bottom 14 and a seat back 16. Such a seat 12 may, for example, be provided within a motor vehicle (not shown). The seat assembly 10 also includes a security organizer, generally designated by reference numeral 18. In the illustrated embodiment, the security organizer 18 is integrated into the rear face 20 of the seat back 16.

The security organizer 18 includes a hard shell cover 22 which may be made from a rigid molded plastic or composite material, a strong, lightweight metal, such as aluminum, or other appropriate material.

The security organizer 18 also includes a security lock mechanism 24 for securing the hard shell cover 22 in a closed position as illustrated in FIG. 1.

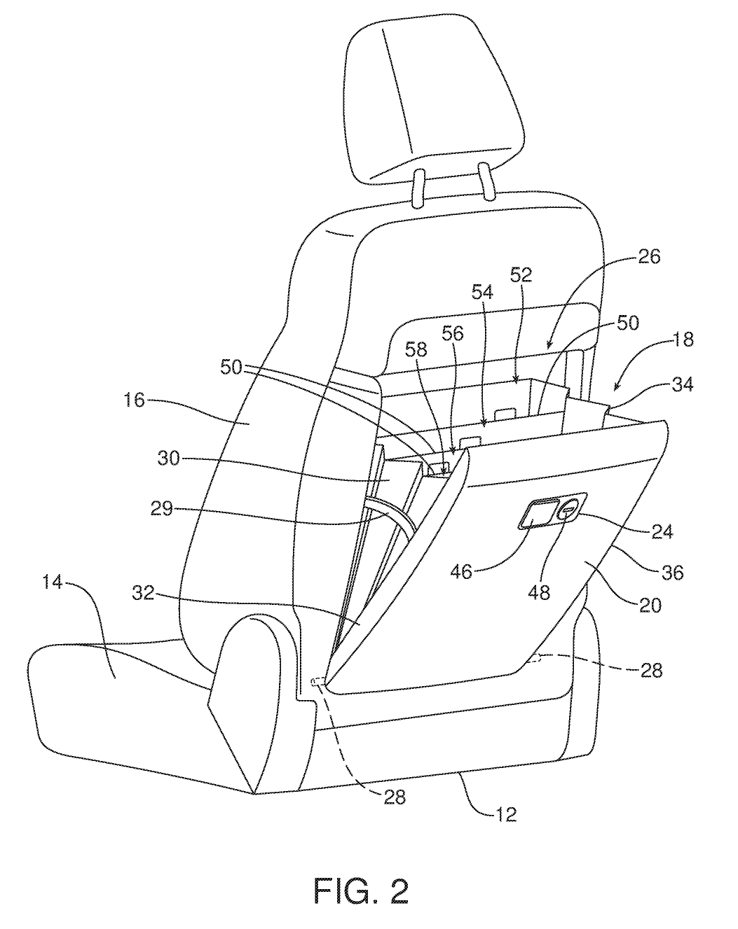

The security lock mechanism 24 may be released to allow one to displace the hard shell cover 22 from the closed position illustrated in FIG. 1 to the opened position illustrated in FIG. 2 in order to allow access to the security compartment 26 of the security organizer 18. As should be appreciated from viewing FIG. 1, that security compartment 26 is fully closed and concealed by the hard shell cover 22 when the hard shell cover is in the closed position.

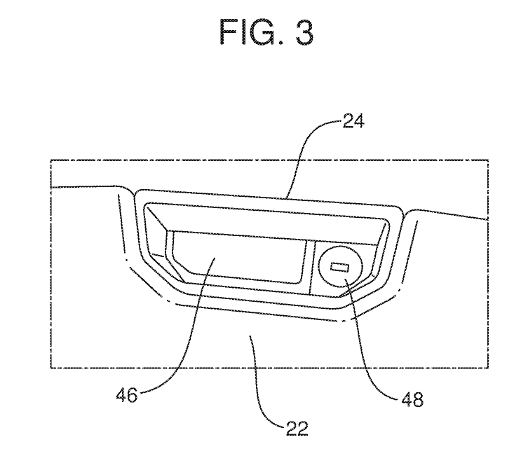

As best illustrated in FIG. 3, the hard shell cover 22 is connected to the seat back 16 by means of a hinge 28. A strut 29 limits how far the hard shell cover 22 will open. A similar strut (hidden from view) may be provided at the opposite side of the hard shell cover 22. A first collapsible sidewall 30 extends between the seat back 16 and a first side margin 32 of the hard shell cover. Similarly, a second collapsible sidewall 34 extends between the seat back 16 and a second side margin 36 of the hard shell cover 22.

In the illustrated embodiment, the seat back 16, the first collapsible sidewall 30, the second collapsible sidewall 34 and the inner face of the hard shell cover 22 define the security compartment 26. The first collapsible sidewall 30 and the second collapsible sidewall 34 may all be made from a flexible material such as a soft fabric or plastic. When the hard shell cover 22 is in the closed position, the first collapsible sidewall 30 and the second collapsible sidewall 34 may be maintained concealed behind the hard shell cover 22 in order to provide a more aesthetically pleasing appearance.

In the embodiment illustrated in FIGS. 1-3, the security lock mechanism 24 includes a push button actuator 46 and a key cylinder lock mechanism 48 which allows the opening or release of the security lock mechanism 24 by means of a dedicated key (not shown). As illustrated, the actuator 46 and key lock cylinder 48 may be provided side-by-side on the hard shell cover 22. When the key cylinder lock mechanism 48 is unlocked, the security compartment 26 may be easily accessed by pushing the push button actuator 46 and pivoting the hard shell cover 22 into the opened position about the hinge 28 as illustrated in FIG. 3.

As best illustrated in FIG. 2, the seat assembly 10 may also include one or more partitions 50. In the illustrated embodiment, the seat assembly 10 includes three partitions 50 for dividing the security compartment 26 into four sections 52, 54, 56, 58 which may be used by an individual to organize paperwork such as files, folders, notepads, magazines, pamphlets and other documents in substantially any desired manner. As should be appreciated, each of the sections 52, 54, 56, 58 is secured and concealed when the hard shell cover 22 is in the closed position illustrated in FIG. 1. In contrast, when the hard shell cover 22 is in the opened position illustrated in FIG. 2, each of the sections 52, 54, 56, 58 is easily accessed to allow one to organize and store or remove a desired piece of paperwork. As illustrated in the embodiment of FIGS. 1-3, the security lock mechanism 24 is mechanical in nature.

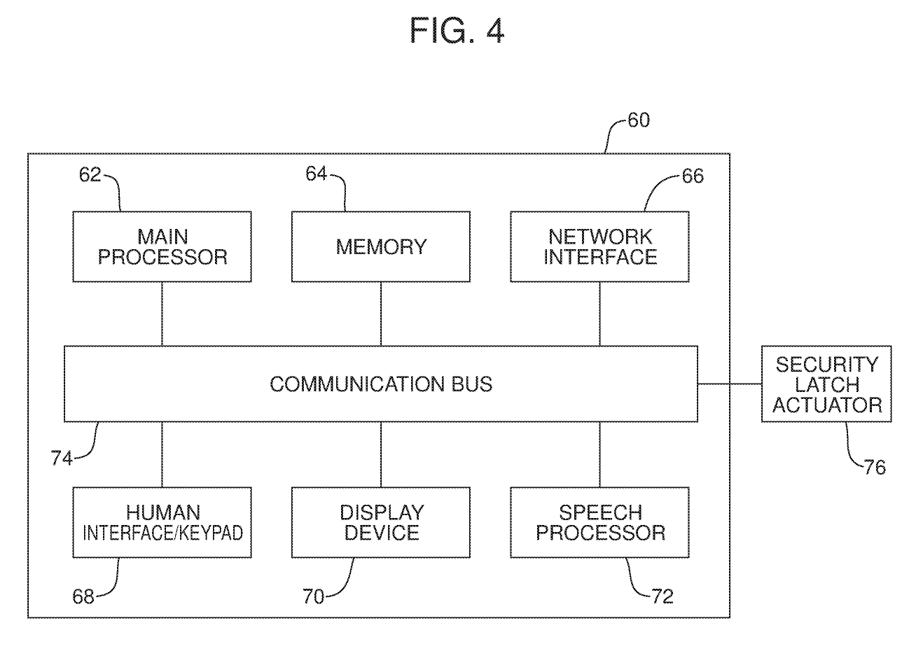

As illustrated in FIG. 4, the security lock mechanism 24 may be electronic in nature and depend upon a controller 60. Controller 60 may be a computing device comprising a dedicated microprocessor or electronic control unit (ECU) operating in accordance with instructions received from appropriate control software. As illustrated in FIG. 4, the controller 60 includes one or more processors 62, one or more memories 64, one or more network interfaces 66, a human interface such as a keypad 68, a display device such as a multi-function display with touchscreen capability 70 and a speech processor 72 that all communicate with each other over a communication bus 74. In such an embodiment, the security lock mechanism 24 may be released by, for example, entering an appropriate code by means of the human interface/keypad 68 or the touchscreen display device 70. Alternatively, the security lock mechanism 24 may be released or activated by voice command via the speech processor 72.

Thus, upon the entry of an appropriate code or recognition of an appropriate voice command, the controller 60 functions to send an appropriate command to the security latch actuator 76 which functions to release or activate the security lock mechanism 24 in accordance with the desires of the operator.

The foregoing has been presented for purposes of illustration and description. It is not intended to be exhaustive or to limit the embodiments to the precise form disclosed. Obvious modifications and variations are possible in light of the above teachings. For example, in the illustrated embodiment the security compartment 26 is divided into four sections 52, 54, 56, 58 by three partitions 50. Fewer or more partitions 50 may be provided as desired. In some embodiments, the human interface 68 may comprise a fingerprint scanner to limit authorized access to the security compartment 26 to a particular individual. All such modifications and variations are within the scope of the appended claims when interpreted in accordance with the breadth to which they are fairly, legally and equitably entitled.

What is claimed:

1. A seat assembly, comprising:
a seat including a seat bottom and a seat back; and
a security organizer integrated into said seat back, said security organizer including a hard shell cover, a security lock mechanism securing said hard shell cover in a closed position and a security compartment fully closed and concealed by said hard shell cover when in said closed position.

2. The seat assembly of claim 1, further including at least one partition in said security compartment dividing said security compartment into multiple sections.

3. The seat assembly of claim 2, wherein said security lock mechanism includes a latch element, a striker and an actuator.

4. The seat assembly of claim 3, wherein said striker is carried on said seat back and said latch element and said actuator are carried on said hard shell cover.

5. The seat assembly of claim 4, wherein said hard shell cover is connected to said seat back by means of a hinge.

6. The seat assembly of claim 5, further including a first collapsible sidewall extending between said seat back and a first side margin of said hard shell cover.

7. The seat assembly of claim 6, further including a second collapsible sidewall extending between said seat back and a second side margin of said hard shell cover.

8. The seat assembly of claim 7, wherein said security lock mechanism is electronic.

9. The seat assembly of claim 8, wherein said security lock mechanism includes a keypad.

10. The seat assembly of claim 7, wherein said security lock mechanism includes a key cylinder.

11. The seat assembly of claim 7, wherein said security lock mechanism includes a voice actuation circuit.

12. The seat assembly of claim 1, wherein said security lock mechanism is electronic.

13. The seat assembly of claim 1, wherein said security lock mechanism includes a keypad.

14. The seat assembly of claim 1, wherein said security lock mechanism includes a key cylinder.

15. The seat assembly of claim 1, wherein said security lock mechanism includes a voice actuation circuit.

16. The seat assembly of claim 1, wherein said security lock mechanism includes a fingerprint scanner.
